(19) United States
(12) Patent Application Publication
(10) Pub. No.: US 2003/0140861 A1
(43) Pub. Date: Jul. 31, 2003

(54) Valve

(76) Inventors: Timothy Clarke, Cloverlea (AU); Laurie Harold Davis, Lillico (AU)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/311,415

(22) PCT Filed: Jun. 18, 2001
(86) PCT No.: PCT/AU01/00722

(30) Foreign Application Priority Data
Jun. 20, 2000 (AU) PQ8238

(51) Int. Cl. A01J 3/00; A01J 5/00

(52) U.S. Cl. 119/14.17

(57) ABSTRACT

The invention provides a valve (100) comprising, a housing (61) having ant enclosed internal cavity (66), an aperture (68) formed in a wall of the housing providing communication with the enclosed internal cavity, a valve scat (72) surrounding the aperture, an expandable valve member (40) mounted within the housing the expandable valve member having a hollow interior surrounded by a side wall of the expandable valve member, the side wall and hollow interior extending through a portion of the internal cavity clear of the housing where it terminates in an end wall (50), and a port (67) communicating with the hollow interior, wherein the construction and mounting of the expandable valve member and housing re such that the internal cavity of the housing may be evacuated to provide a region of sub-atmospheric pressure around the expandable valve member whereby the application of air pressure greater than sub-atmospheric pressure through the port can act to expand the expandable valve member to bring the end wall (50) into sealing engagement with the valve seat (72), the expandable valve member resiliently contracting to move the end wall out of sealing engagement with the valve seat when air pressure in the internal cavity and hollow interior arc the same.

### FIELD OF THE INVENTION

This invention relates to valves for the control of the flow of fluids and in a particular non limiting aspect relates to methods and devices for hygienic remote control of milk flow is an evacuated milking machine.

### BACKGROUND OF THE INVENTION

Fluid flow control devices incorporating valves are needed in a range of industrial and agricultural applications. In a particular application such control devices are needed in relation to measuring performance of lactating animals such as cows that are machine milked under vacuum. A valve for a milking system that requires only inputs of atmospheric pressure and regulated vacuum from the milking system to control milk flow has obvious advantages as these are already inherently available from the system. In addition if the valve can be so constructed as to be easily cleanable, small, flexible, durable and have no moving parts, it will have advantages with respect to hygiene, cost and speed and consistency of operation even under adverse pressure conditions.

### DISCLOSURE OF THE INVENTION

The invention provides

a hygienic valve suitable for controlling flow of food containing fluids comprising,

a housing having an enclosed internal cavity for holding the food containing fluids,

an aperture formed in a wall of the housing providing communication with the enclosed internal cavity,

a valve seat surrounding the aperture,

an expandable valve member mounted within the housing the expandable valve member having a hollow interior surrounded by a side wall of the expandable valve member, the hollow interior being sealed against communication with the enclosed internal cavity, the side wall and hollow interior extending through a portion of the internal cavity clear of the housing where it terminates in an end wall, and

a port communicating with the hollow interior,

wherein the construction and mounting of the expandable valve member and housing are such that the internal cavity of the housing may be evacuated to provide a region of sub-atmospheric pressure around the expandable valve member whereby the application of atmospheric pressure through the port can act to expand the expandable valve member to bring the end wall into sealing engagement with the valve seat, the expandable valve member resiliently contracting to open the hygienic valve by moving the end wall out of sealing engagement with the valve seat when air pressure in the internal cavity and hollow interior are the same and the valve seat is arranged to allow drainage of the food containing fluids from the enclosed internal cavity when the hygienic valve is open.

The aperture may form an inlet or outlet for fluid flow, particularly milk and/or air It may form an integral part of a component of a milking machine. For example, it may constitute a drainage hole for a milk meter, particularly a milk meter of the type described in applicants' co-pending international application PCT/AU01/00243. All the disclosures of the said international application are, by this cross reference, deemed to be incorporated in this specification. The drainage hole of the milk meter described in the international application may drain into a evacuated milking line of the type commonly found in milking machines.

Where the drainage hole is formed in a milk meter, the meter may typically include a housing in the form of an enclosed chamber. The chamber may be constructed so that it can receive milk under vacuum or reduced pressure from a milking machine. In such an arrangement the drainage hole may be provided in the base of the milk meter or in a low lying drainage portion of the meter.

The valve seat may simply be any region surrounding the aperture which can form a seal with the valve member. It may be profiled or shaped to facilitate sealing. It may be a flat surface.

In another aspect of the invention the valve may include a mounting tube. The mounting tube may be held in the port. It may be co-axial therewith. Suitably the mounting tube can act as a conduit for the movement of fluid, such as air, to control the expansion and contraction of the expanding portion.

Control of fluid flow through the port may suitably be achieved using a control means, such as a solenoid valve. The control means may be arranged to so to allow ingress of atmospheric air or positive pressure through the port into the hollow interior. It may also control provision of vacuum suction through the port. Such vacuum suction may be provided by a milking machine. It may also close the port to isolate the hollow interior from suction and open it to other pressure.

Preferred embodiments of the invention will now be described with reference to the accompanying drawings.

### BRIEF DESCRIPTION OF THE DRAWINGS

FIG. 1 is a plan view of a part of a valve according to the invention;

FIG. 1a is an elevational view of a cross section through the valve of FIG. 1;

FIG. 2 is a plan view of a part of a valve with two apertures;

FIG. 2a is an elevational view of a cross section through the valve of FIG. 2;

FIG. 3 is a plan view of a part of a double acting valve with two apertures;

FIG. 3a is an elevational view of a cross section through the double acting valve of FIG. 3;

FIG. 4 is a plan view of a part of an alternative valve construction;

FIG. 4a is an elevational view of a cross section through the alternative valve of FIG. 4;

FIG. 5 is an elevational view of an expandable valve member for use in the invention;

FIG. 5a is an elevational view of the valve member of FIG. 5 after expansion;

FIG. 5b is an elevational view of a perpendicular section taken through the expandable valve member of FIG. 5; and

FIG. 6 is an elevational sectional view of a milk meter incorporating the valve member of FIG. 5.

### DETAILED DESCRIPTION OF THE PREFERRED EMBODIMENTS

In the drawings the use of like reference numerals refers to equivalent integers.

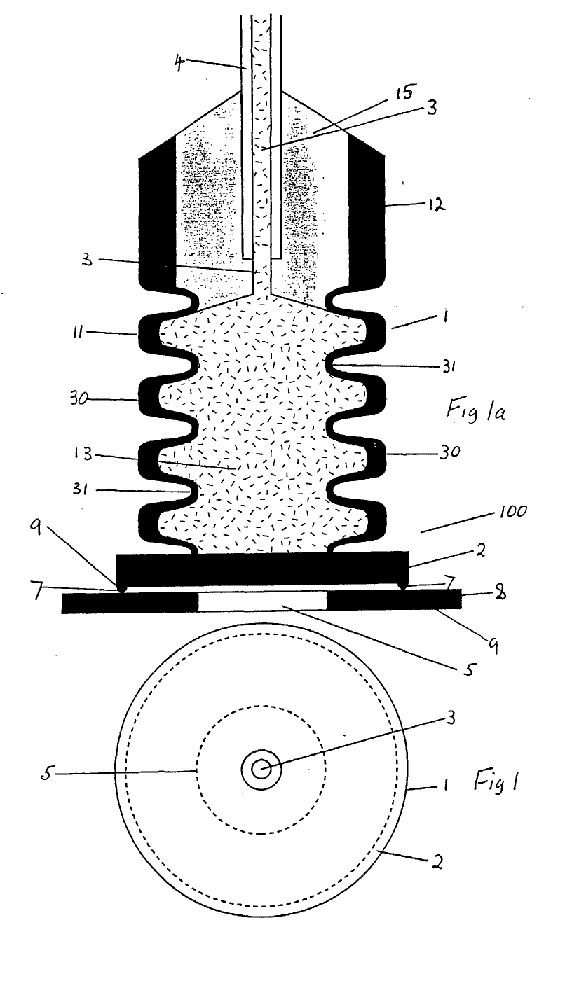

Referring to FIG. 1 the valve 100 includes an expandable valve member 1. The valve member is provided with an expandable gas tight bellows 11. The bellows is connected at one end by the mounting collar portion 12 to the mounting stopper 15. The mounting stopper is provided with a port 3. The port 3 communicates with the hollow interior 13 define by the bellows and also facilitates mounting of valve member on a hollow mounting tube. The port 3 is connected via the hollow mounting tube 4 to a pressure control valve (not shown) such as a multi-port solenoid valve for regulating gas pressure and/or suction such as from a milking machine. One end of the expandable valve member is formed as a sealing portion. This takes the form of a valve foot 2. The valve foot 2 should be sufficiently stiff to resist buckling or bending when the bellows expands or contracts in order that it can provide an effective seal against a sealing surface. Thus it is preferred that the valve foot have a thickness of at least 2 mm more preferably about 4 mm.

The valve member is shown as a two piece construction consisting of bellows and mounting stopper each of which may have been produced by a conventional moulding process such as injection moulding. The valve bellows, foot and mounting stopper 15 can be made of silicone rubber and to aid sealing, the valve member 1 can have a small raised lip 7 around the perimeter of the under side of the valve foot 2. The bellows comprise a number of annular ribs 30 alternating with annular channel portions 31. The ribs are thicker than the channel portions so that the thicker ribs provide strength while the thinner channel portions provide a resilient flexibility to facilitate longitudinal expansion and contraction of the valve member.

The valve member is mounted above a surface 8 which includes a round aperture 5. The surface comprises a section a wall of a housing. The housing can be any shape. Hence, the drawing only shows a small portion of a wall of the housing. The housing has an internal cavity in which the expandable valve member is located. The aperture which allows communication between the internal cavity and the exterior can be sealed and unsealed by the valve member. The valve seat 9 is a region of the surface 8 immediately below the sealing portion of the valve member, namely the lip 7. In the illustrated embodiment the valve seat is simply a flat portion of the surface 8. However it is to be understood that in some alternative configurations it may have a shaped or profiled surface which facilitates sealing with a complementary sealing portion of the valve member.

It is noted that the surface 8 may-form the base of an enclosed vessel such as the milk meter described in an applicants' co-pending international application PCT/AU01/00243. In such a case, the aperture may be arranged to drain milk from the milk meter into an evacuated milking line of a milking machine.

During operation, when pressure on the inside of valve member 1 is equal to the pressure outside, the valve member assumes its natural moulded shape. When the internal pressure is greater than the pressure in the internal cavity, the bellows expands to move the valve foot 2 into sealing engagement with the valve seat and the aperture will be closed entirely. The pressure differential may be achieved by reducing pressure in the internal cavity to sub-atmospheric pressure whilst allowing the hollow interior to remain at atmospheric pressure. When the pressure inside the valve member is at the level of internal cavity, the valve member will through its own elasticity return to its natural moulded shape and cause the valve to open. If required the valve can be opened even further by reducing the internal pressure to cause the valve to collapse. By remote pressure differential regulation, fluid flow through the aperture can be controlled.

In an alternative approach the valve member can be seated against the aperture in its natural moulded state. Then pressure reduction inside the member may cause the bellows to contract and cause the valve to open.

Valves of the above design are particularly suited to the control of milk and air flow in a dairy milking environment where regulated vacuum is used in the machine milking of cows. The milking vacuum on the outside of the valve coupled with the same vacuum on the inside can cause the valve to open. When atmospheric air to pressure is applied to the inside through the port the valve will close. Such a fluid control system requires no additional sources of pressure or vacuum. The valves of the above design in suitable silicone rubber can withstand millions of operations without significant deterioration or changed performance.

In a machine milking apparatus, occasionally for a variety of reasons such as inadvertent air admission, the vacuum may fall well below the desired level. The valves of this design can be so designed that they continue to work well even when milking vacuum levels are badly compromised.

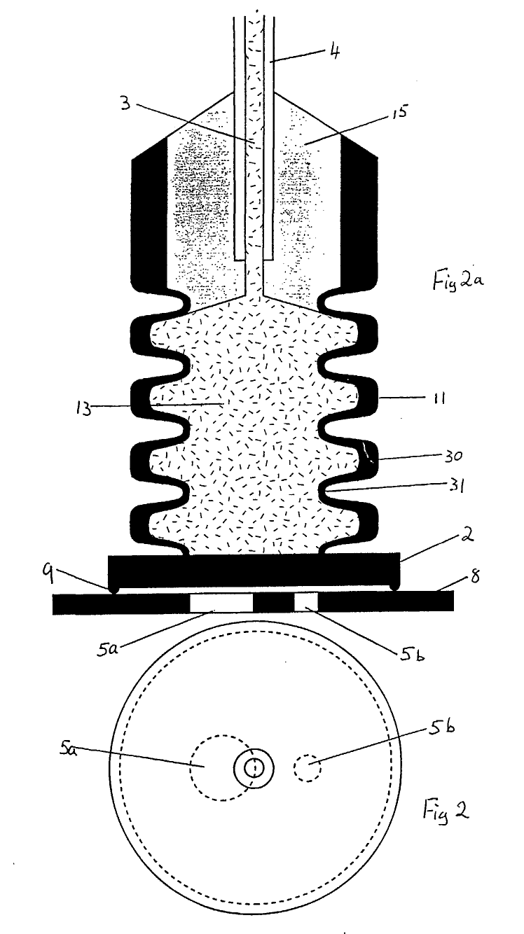

Referring to FIGS. 2 and 2a of the drawings there is shown a valve arrangement along the lines of that shown with respect to FIGS. 1 and 1a, the main difference being that the surface 8 which may comprise a wall forming the base of a milk meter includes two apertures 5a and 5b. These are both arranged so that they can be sealed by the sealing portion or valve foot 2. In this configuration, for example, the larger aperture 5a may direct milk to a conventional milking line whereas the smaller aperture 5b may be used for any suitable purpose such as for providing small samples of milk to a sampling line. The opening and closing of the valve for each aperture is controlled by differential pressure as described with respect to FIGS. 1 and 1a.

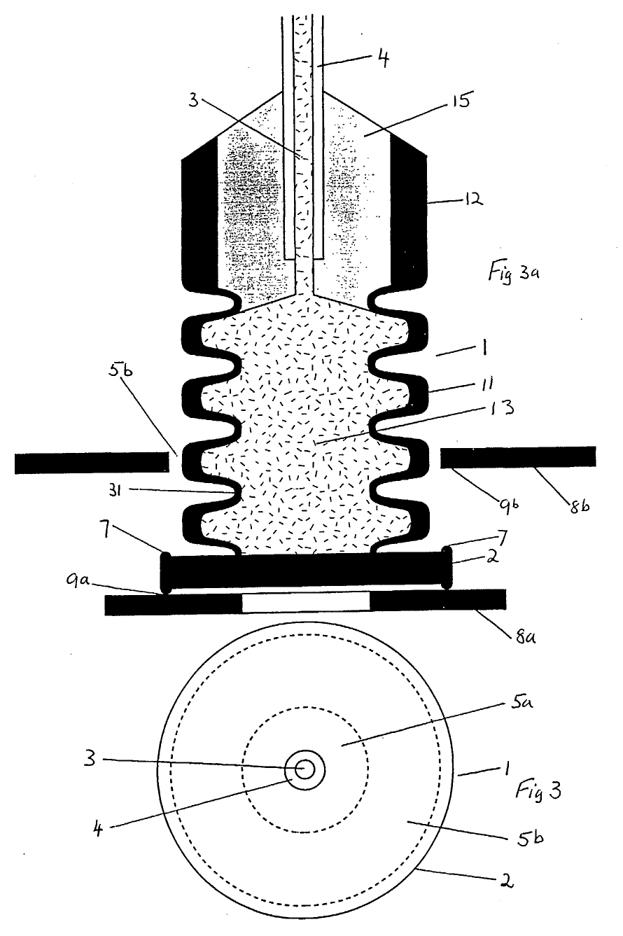

Referring to FIGS. 3 and 3a, the double acting valve shown therein includes two surfaces 8a and 8b upon which the valve foot 2 of the valve member 1 may impinge the circumferential lips 7 to seal and unseal the respective apertures 5a and 5b. The aperture 5a may comprise a wall of a housing which can be evacuated. Thus the surface 8b and aperture 5b will lie within the internal cavity of the housing.

In this particular configuration the valve foot 2 includes circumferential lips 7 on its upper and lower surface so that it may seal against the surface 8a and 8b as the bellows expands the valve foot seal against the aperture 5a and allow flow of fluid through the aperture 5b into the region bounded by the surfaces 8a and 8b. When the bellows are contracted they seal off the aperture 5 band open the aperture 5a. Thus any fluid in the region bounded between the surfaces 8a and 8b may flow through the aperture 5a.

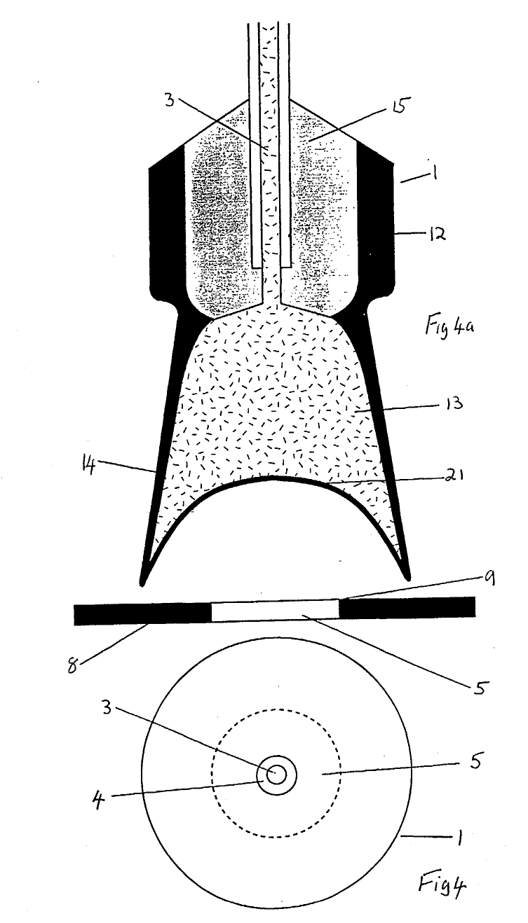

Referring to FIGS. 4 and 4a, there is shown an alternative configuration of the valve member in which the expandable portion of the member is in the form of a flexible sealing surface 21 which closes off the hollow interior 13 at one end of the valve member. The flexible sealing surface is attached to a stiff circumferential wall 14 at one end, the wall also being attached to the solid mounting portion 12 at its other end.

When a pressure differential is applied such that the hollow interior 13 is at a greater pressure than the pressure external to the valve member 1, the flexible sealing surface 21 currently shown in a concave configuration in the drawing flexibly flips over to a convex configuration so that it closes off the aperture 5.

In its convex configuration, the wall of the flexible sealing surface will impinge upon the edges of the aperture 5 so that they act as a valve seat 9.

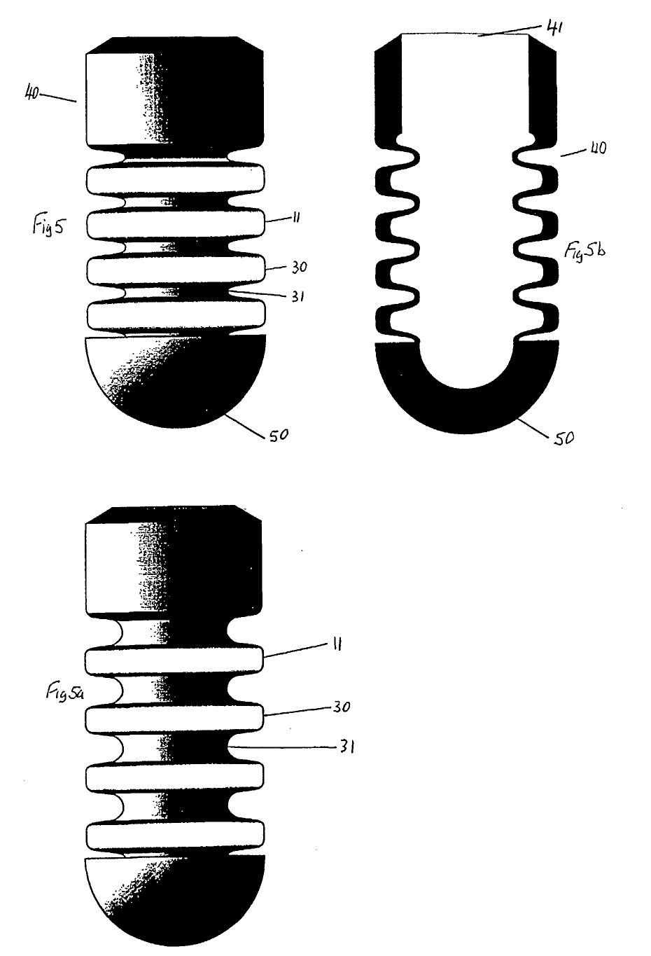

Referring to FIGS. 5, 5a and 5b, the expandable valve member 40 differs mainly from that shown in the earlier Figures in that it has a thick rounded sealing foot 50 for sealing against the edges of an aperture. The open mouth 41 is shaped to receive a plug with a port and a mounting tube (not shown). The plug and tube may comprise an integral member moulded from plastics material. Otherwise it is very similar in construction and function.

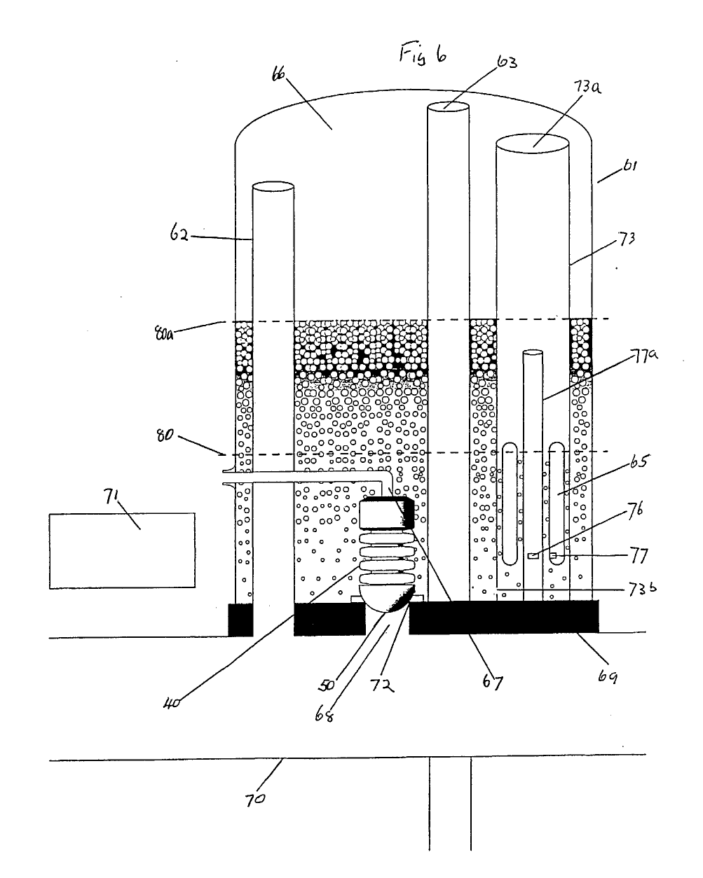

Referring to FIG. 6 there is shown a milk meter which comprises a housing in the form of a collection vessel 6. The collection vessel acts as a holding chamber for milk being measured and defines an internal cavity 66 in which the valve member 40 is located. The vessel is sealed to a meter base 69 which has provision for a head space vacuum tube 62 and a calibrated aperture in the form of a milk drainage hole 68 which are both connected to the evacuated milk line 70. The base 69 may be removable to facilitate cleaning of the meter.

A milk inlet tube 63 from the long milk delivery tube is provided to deliver the milk into the collection vessel 61. A foam bypass chamber 73 in the form of a vertically extending cylinder with an open top 73a is mounted within the collection vessel 61. An inlet 73b provided at the bottom of the cylinder allows flow of milk into the bypass chamber from the collection vessel, the low position of the inlet serving to restrict foaming milk from entering the bypass chamber. The milk outlet hole 78 is sealed by a fast acting valve member 40 shown in more detail in FIGS. 5, 5a and 5b. The valve member seals on the valve seat 72 which is the edge of the hole 68. The valve member is opened for a fixed period of time (t) by the valve controller and timer 71 which regulates supply of air through the port 67. The valve member is triggered by the proximity switch 76 which is activated or deactivated by presence or absence of the proximity material 77 embedded in the float 65 which is housed in foam bypass chamber 73. The float is supported by buoyancy of the milk whose level is shown by the dotted line 80 in the foam bypass chamber 73. The float is annular and surrounds a fixed vertical post 77a in which the proximity switch is embedded. The float may telescopically slide up and down the post with changing milk levels. Beneath the dotted line 80a the milk and foam in the collection vessel exerts the same hydraulic pressure as does the substantially foam free milk below level 80 in foam bypass chamber 73. If the cross sectional area of vessel 61 is essentially uniform between the highest fill level and the low drainage level, then a consistent weight or net volume of milk will be present in the meter at the point in time when the valve opening is initiated. This ensures that, regardless of the foam content of the accumulated milk, the meter contains a standardised quantity of milk at the initiation of each dumping of milk. The dotted line 80a shows a high milk level which activates valve opening.

The volume of milk and flow rate can be estimated as follows:

V=c+(n×q)

F=q/a

where:

V=volume of milk passed through the meter

F=the flow rate

c=the average volume of milk that will not be automatically drained

n=number of valve openings recorded by the counter

q=the average volume of milk drained during a single drainage period (t)

a=the time that has elapsed between the detection of the previous high level event and the current one

Alternatively, a better estimate of milk yield can be made where the volume of each milk dump is estimated by adjusting it by a factor which allows for the impact of different milk inflow rates on the volume of milk dumped during time t.

$$\begin{matrix}V = c + {\sum }_{i = l}^{n} {V}_{i} . & equation 1 \\ {V}_{i} = {V}_{o} \frac{d}{{\tilde{a}}_{i} - e} . & equation 2 \\ {F}_{i} = \frac{{V}_{i}}{{\tilde{a}}_{i}} & equation 3 \\ {F}_{n} = \frac{{V}_{o}}{{a}_{n}} & equation 4\end{matrix}$$

Where

V=an estimate of quantity of milk from a milking cow

i=number of milk dumps since the start of milking

n=the number of dumps to the end of milking

c=an estimate of the average quantity of milk that will not be automatically dumped at the end of milking

Vᵢ=the particular quantity of milk that is dumped in time t dumpᵢ.

Fᵢ=an estimate of milk inflow rate which resulted in dumpᵢ.

Fₙ=an estimate of terminal milk inflow rate

V₀=the particular quantity of milk dumped in time t when milk in-flow rate approaches zero

d=a constant

e=a constant

constants d and e are selected so that when they are substituted into equation 2, they cause Vᵢ to approximate the amount of milk that is dumped through the valve during valve open time t, for a range of milk inflow rates ranging from zero to the maximum flow rate expected from any cow.

aᵢ=the time that has elapsed between the detection of the current high level event prior to dumpᵢ and the previous high level event.

ãᵢ=smoothed estimate of aᵢ, such as the running average of a (i−1) and aᵢ

A particular combination of the above factors which has given accurate milk yield and flow rate is-described below where the milk meter had a chamber diameter of 100 mm and a high liquid level (5) that was 40 mm above the drainage hole (8) which had a diameter of 19.0 mm and a fixed valve open time of 2.00 seconds and was designed to perform with flow rates up to 150 gram/second (9 Kg/minute).

$$\begin{matrix}V = c + {\sum }_{i = l}^{n} {V}_{i} \\ V = 300 + {\sum }_{i = l}^{n} {V}_{i} \\ {V}_{i} = {V}_{o} + \frac{d}{{\tilde{a}}_{i} - e} & equation 1 \\ {V}_{i} = 234 + \frac{66}{{\tilde{a}}_{i} - 1} & equation 2 \\ {F}_{i} = \frac{{V}_{i}}{{\tilde{a}}_{i}} & equation 3 \\ {F}_{n} = \frac{{V}_{o}}{{a}_{n}} \\ {F}_{n} = \frac{234}{{a}_{n}} & equation 4\end{matrix}$$

Where

V an estimate of yield of milk in grams

The flow rate Fₙ from this estimation will be most accurate near the end of milking when flow rate is low. Flow rate in the diary industry is also most important when milk flow is low. Alternatively, if required milk flow rate can also be more generally estimated by Fᵢ at any stage of milking.

If a very high milk inflow rate causes the level switch to be held in the high position after time (t) has elapsed, then successive drainage sequences of time (t) can occur until the normal stop start mode of operation occurs. Under these conditions, the signal from the high level switch can be taken as registering a high reading for multiples of time t until the float falls once more.

It is most desirable for milk meters to be as small as possible so that they can be easily accommodated in the diary shed. The cross sectional area of the collection vessel can be as large as 30,000 mm² or as small as 2,000 mm², but should preferably be about 10,000 mm².

The head height of the liquid at the high level point can be from 20 to 150 mm but more preferably about 40 mm. Time t can be from 0.5 to 5.0 seconds, but more preferably about 2.0 seconds. Drainage holes of 19 mm diameter have been found to be suitable with a time t of about 2 seconds. Smaller diameters could be used, but these would limit the accuracy of the meter at high in-flow rates. Larger diameters could also be used with corresponding smaller valve open times, but larger and possibly slower valves would be required to seal the hole.

The float 5 which moves with the liquid milk level is required to have a low enough density to cause it to float in liquid milk but high enough to ensure there is a strong downward force acting upon it when the milk level falls and the float is required to move downwards against surface tension forces from surrounding surfaces. Ester resin filled with suitable amounts of micro glass bubbles for example can be used to make such floats.

It should be understood that the measurement of milk volume as described in this invention can similarly apply to the estimation of either the volume of weight of milk having due consideration for the mean density of milk. The invention also provides a means of estimating the milk flow rate during milking and this measurement will be most accurate at low inflow rates where milk flow rate information is most needed to monitor the milking process.

The milk meter of this invention can be very accurate over a wide range of inflow rates.

The measurement principle is such that the accuracy of milk measurement is not greatly dependent on small variations in the size and shape of the collection vessel or the exact determination of the level of milk which triggers the initiation of the milk drainage phase or the rate of inflow of milk from the animal. The graph shown in FIG. 3 demonstrates that high levels of accuracy can be obtained in normal conditions over a wide range of milked volumes.

The simple components required can make it inexpensive to make and easy to clean and service.

The simple operation of the meter is easy to understand and its proper function can consequently be monitored by the farmer.

The meters of this invention can maintain their accuracy even though the milk may be made quite foamy by the particular milking process, milk transport system and or by the diet of the cow.

The output from the device makes it simple to transfer the output data to mechanical or electronic counters, data loggers or a computer and to convert it into milk yield and flow rate estimates according to the above equations.

If the collection vessel is made of transparent material then it is easy to observe the correct function of the device and whether or not cleaning has been effective.

A benefit of the pulsatile dumping of standard milk charges is that it allows simple samplers to take accurately representative samples of milk from a milking.

Furthermore, the holding zone, particularly if it is of small volume may be used to make milk composition measurements in line and to make a composition profile for the milking of each cow. Mastitis detection through conductivity profiles is one real possibility.

It is to be understood that the word comprising as used throughout the specification is to be interpreted in its inclusive form ie. use of the word comprising does not exclude the addition of other elements.

Finally, it is to be understood that the inventive concept can be incorporated in many different constructions and with alternative components so that the generality of the preceding description is not be superseded by the particularity of the attached drawings. Various alterations, modifications and or additions may be incorporated into the various constructions and arrangements of parts or be applied to metering other fluids without departing from the spirit and ambit of the invention.

1. A hygienic valve suitable for controlling flow of food containing fluids comprising,
a housing having an enclosed internal cavity for holding the food containing fluids,
an aperture formed in a wall of the housing providing communication with the enclosed internal cavity,
a valve seat surrounding the aperture,
an expandable valve member mounted within the housing the expandable valve member having a hollow interior surrounded by a side wall of the expandable valve member, the hollow interior being sealed against communication with the enclosed internal cavity, the side wall and hollow interior extending through a portion of the internal cavity clear of the housing where it terminates in an end wall, and
a port communicating with the hollow interior,
wherein the construction and mounting of the expandable valve member and housing are such that the internal cavity of the housing may be evacuated to provide a region of sub-atmospheric pressure around the expandable valve member whereby the application of atmospheric pressure through the port can act to expand the expandable valve member to bring the end wall into sealing engagement with the valve seat, the expandable valve member resiliently contracting to open the hygienic valve by moving the end wall out of sealing engagement with the valve seat when air pressure in the internal cavity and hollow interior are the same and the valve seat is arranged to allow drainage of the food containing fluids from the enclosed internal cavity when the hygienic valve is open.

2. A valve according to claim 1 wherein the side wall comprises a bellows which is expandable in response to pressure in the hollow interior being greater than pressure in the enclosed internal cavity.

3. A valve according to claim 2 wherein the bellows comprises a plurality of annular ribbed portions alternating with a plurality of annular channel portions of lesser diameter than the annular ribbed portions and the thickness of the side wall comprising the annular ribbed portions is greater than the thickness of the side walls comprising the annular channel portions.
means are arranged to count the number of times (n), milk has been drained from the housing.

10. A milk meter according to claim 9 wherein the measuring means provides a calculation of the amount of milk (V) which has passed through the milk meter by multiplying the (n) by (q), the average volume of milk drained during the period of time (t).

11. A milk meter according to claim 10 wherein the measuring means is arranged to add a constant (e) to (V) to take account of the average volume of milk which remains in the meter and other associated equipment after flow of milk through the meter has stopped.

12. A milk meter according to claim 9 wherein the measuring means is arranged to calculate the amount of milk (V) which has passed through the milk meter by calculating (V) in accordance with the following equations:
$$\begin{matrix}V = c + {\sum }_{i = l}^{n} {V}_{i} . & equation 1 \\ {V}_{i} = {V}_{o} \frac{d}{{\tilde{a}}_{i} - e} . & equation 2 \\ {F}_{i} = \frac{{V}_{i}}{{\tilde{a}}_{i}} & equation 3 \\ {F}_{n} = \frac{{V}_{o}}{{a}_{n}} & equation 4\end{matrix}$$
where
i=number of times milk has been drained since the beginning of the milk flow,
n=the number of drainages to the end of milk flow,
c=a constant being an estimate of the average quantity of milk that will not be automatically drained at the end of milking,
Vᵢ=the particular quantity of milk that is drained in time t drain i,
Fᵢ=an estimate of milk inflow rate which resulted in drain i
Fₙ=an estimate of terminal milk inflow rate,
V₀=the particular quantity of milk dumped in time t when milk in-flow rate approaches zero,
d=a constant
e=a constant
and constants d and e are selected so that when they are substituted into equation 2, they cause Vᵢ to approximate the amount of milk that is drained during time t, for a range of milk inflow rates ranging from zero to the maximum flow rate expected from any cow,
aᵢ=the time that has elapsed between the detection of the milk reaching the predetermined level prior to drainᵢ and the previous event of the milk reaching the predetermined level, and
ãᵢ=smoothed estimate of aᵢ, which is the running average of a₍ᵢ₋₁₎ and aᵢ

13. A milk meter according to claim 9 wherein the foam bypass chamber is located within the housing and comprises a tube which reaches higher than the predetermined level, the tube having an open upper end, and the milk meter comprises a base on which the tube and holding chamber are mounted, the inlet being located at or near the base and the aperture being formed in the base.

14. A milk meter according to claim 9 wherein the sensing means comprise,
a float arranged in the foam bypass chamber, the float having a density of 0.7 to 1.0, and
a proximity switch responsive to the level of the float.

15. A milk meter according to claim 9 wherein the drainage means comprise, an aperture having a cross sectional area in the range 78 mm² to 314 mm²,
and the valve is arranged to open and close the aperture in response to signals from the timer and the proximity switch.
